(19) United States
(12) Patent Application Publication
(10) Pub. No.: US 2017/0261390 A1
(43) Pub. Date: Sep. 14, 2017

(54) HYDRAULIC TORQUEMETER

(71) Applicant: SAFRAN HELICOPTER ENGINES, Bordes (FR)

(72) Inventor: Laurent HOUSSAYE, Saint Faust (FR)

(73) Assignee: SAFRAN HELICOPTER ENGINES, Bordes (FR)

(21) Appl. No.: 15/508,807

(22) PCT Filed: Sep. 7, 2015
(86) PCT No.: PCT/FR2015/052367

§ 371 Date: Mar. 3, 2017

(30) Foreign Application Priority Data
Sep. 8, 2014 (FR) 1458370

(51) Int. Cl. G01L 3/14; F01D 21/00; G01L 5/12

(52) U.S. Cl. CPC G01L 3/1485; G01L 5/12; F01D 21/003; F05D 2220/323; F05D 2240/60; F05D 2260/83

(57) ABSTRACT

A hydraulic torquemeter comprising a rod which is translatable in a longitudinal direction under the effect of axial thrust which is representative of the torque to be measured, and a hydraulic circuit in which a fluid flows. It also comprises a manometric capsule comprising a pressure chamber which is supplied with fluid by said hydraulic circuit, a sealed flexible membrane which is in contact with the fluid in the pressure chamber, extends in a plane which is substantially perpendicular to said rod, and is rigidly connected to one end of the rod in such a way that a longitudinal movement of the rod deforms the membrane, a drain port for the fluid in said pressure chamber, and a valve designed to adjust the pressure of the fluid in said pressure chamber according to the deformation of said membrane.

### TECHNICAL FIELD OF THE INVENTION

The invention relates to a hydraulic torquemeter. In particular, the invention relates to a hydraulic torquemeter for measuring a torque of a rotating shaft of a turboshaft engine of an aircraft.

### TECHNICAL BACKGROUND

Torquemeters are devices for measuring torque which come in many different forms depending on the field of application, the equipment for which the torque needs to be measured, and the desired degree of precision. Hydraulic torquemeters are used frequently in the field of aeronautics. These torquemeters operate, for example, by means of an intermediate pinion which has helical toothing and of which the rotation brings about axial thrust that is proportional to the torque to be measured. This axial thrust is applied to a piston which is connected to the intermediate pinion.

The piston moving in a manner dependent on the measured torque causes pressure to be exerted on the oil in a measurement chamber, which is supplied by a hydraulic circuit, until the pressure exerted on the oil by the piston and the pressure exerted on the piston by the oil are balanced. A pressure sensor measuring the pressure when this balance is achieved makes it possible to deduce the measured torque.

As is the case for all hydraulic systems, in order to function properly, this type of hydraulic torquemeter requires there to be sealing between the hydraulic circuit and the other parts of the system. In a general manner, this sealing is produced by adding, in particular to the moving piston, one or more O-ring seals, which are usually made of an elastomers To ensure sealing, the O-ring between the piston and the wall of the chamber has to be compressed to a minimum degree. However, this compression creates friction which is proportional to said compression, and this results in imprecisions and can lead to hysteresis phenomena when measurements are being taken. This results in a conflicting situation between effective sealing arid a lack of any resisting forces for allowing the piston to move freely in the chamber.

In order to solve this problem, it has been proposed to use seals made from various materials, such as polytetrafluoroethylene (better known by the acronym PTFE), which makes it possible to reduce the amount of friction between the piston and the chamber. However, using various materials for the seal does not completely erase the hysteresis phenomenon and can create other problems, such as long-term loss of sealing in particular.

### AIMS OF THE INVENTION

The invention aims to overcome at least some of the disadvantages of known torquemeters.

In particular, the invention aims to provide, in at least one embodiment of the invention, a torquemeter that makes it possible to eliminate friction caused by sealing means.

The invention also aims to provide, in at least one embodiment, a torquemeter that does not create hysteresis phenomena.

The invention also aims to provide, in at least one embodiment, a torquemeter that ensures sealing and makes it possible to reduce the amount of friction created during long operating phases.

### DISCLOSURE OF THE INVENTION

In order to do this, the invention relates to a hydraulic torquemeter comprising
a rod which is translatable in a longitudinal direction under the effect of axial thrust which is representative of the torque to be measured,
a hydraulic circuit in which a fluid flows,

characterised in that said torquemeter comprises a manometric capsule comprising:
a pressure chamber which is supplied with fluid by said hydraulic circuit,
a sealed flexible membrane which is in contact with the fluid in the pressure chamber, extends in a plane which is substantially perpendicular to said rod, and is rigidly connected to said rod in such a way that a longitudinal movement of the rod deforms the membrane,
a drain port for the fluid in said pressure chamber, which is joined to a valve supported on one end of said movable rod so as to adjust the pressure of the fluid in said pressure chamber according to the deformation of said membrane.

Therefore, by virtue of a membrane deforming as a result of a translational movement of a movable rod, a torquemeter according to the invention makes it possible to ensure that the pressure chamber comprising the fluid is sealed, without resorting to parts which are in relative motion and of which friction could otherwise bring about measurement errors (hysteresis), The sealing is static in this case, and it is only the membrane that deforms under the momentum of the movement of the rod connected to the membrane. The rod can be rigidly connected to the membrane by its end, by the edge of said rod which passes through the membrane, or by means of a connection part between said rod and the membrane. The drain port is joined to a valve supported on the rod. This means that the valve has a structure which is complementary to the drain port. In other words, the port and the valve are designed to be able to operate together, In practice, the valve is designed to be able to cover the drain port and thus to be able to adjust the pressure of the fluid in the pressure chamber by moving.

Advantageously and according to the invention, the membrane is made of a resilient material such that the deformation of the membrane resulting from a translational movement of said movable rod constitutes elastic deformation.

Advantageously and according to the invention, said rod is hollow and forms part of said hydraulic circuit.

According to this aspect of the invention, the size of the torquemeter is reduced.

Advantageously and according to the invention, said hollow rod passes through said flexible membrane and said drain port for the fluid is provided on the end of said hollow rod.

According to this aspect of the invention, the size of the torquemeter is reduced.

Advantageously and according to the invention, the torquemeter comprises conversion means suitable for applying axial thrust which is representative of the torque to be measured to the rod.

According to this aspect of the invention, the axial thrust is produced by the conversion means so as to be proportional to the torque to be measured in such a way as to allow the movable rod to move.

Advantageously and according to the invention, the torquemeter comprises means for determining the torque according to the pressure of said fluid.

According to this aspect of the invention, the pressure of the fluid makes it possible to deduce the torque to be measured, for example by measuring the pressure value and then converting it, or by directly converting the pressure into information relating to the torque, without directly measuring the pressure value.

Advantageously and according to the invention, the membrane is surrounded by a ring which is held in contact with a shoulder of the pressure chamber by means of a holding collar.

According to this aspect of the invention, the ring, the shoulder and the collar make it possible to hold the membrane in position in a static manner, without said elements moving, and this provides for effective sealing without problems relating to friction or hysteresis.

The invention also relates to a turboshaft engine comprising a rotating shaft, characterised in that it comprises a hydraulic torquemeter according to the invention which is suitable for measuring the torque of the shaft.

The invention also relates to a torquemeter and to a turboshaft engine characterised in combination by all or some of the features mentioned above or below.

### LIST OF THE DRAWINGS

Other aims, features and advantages of the invention will become apparent upon reading the following description, which is given purely by way of non-limiting example and relates to the accompanying drawings, in which:

FIG. 1 is a schematic view of a hydraulic torquemeter according to the prior art,

FIG. 2 is a schematic view of the operation of a hydraulic torquemeter according to an embodiment of the invention,

FIG. 3 is a schematic view of a hydraulic torquemeter according to an embodiment of the invention.

### DETAILED DESCRIPTION OF AN EMBODIMENT OF THE INVENTION

The following embodiments are examples. Even though the description refers to one or more embodiments, this does not necessarily mean that each reference relates to the same embodiment or that the features only apply to a single embodiment. individual features of different embodiments can also be combined in order to provide other embodiments.

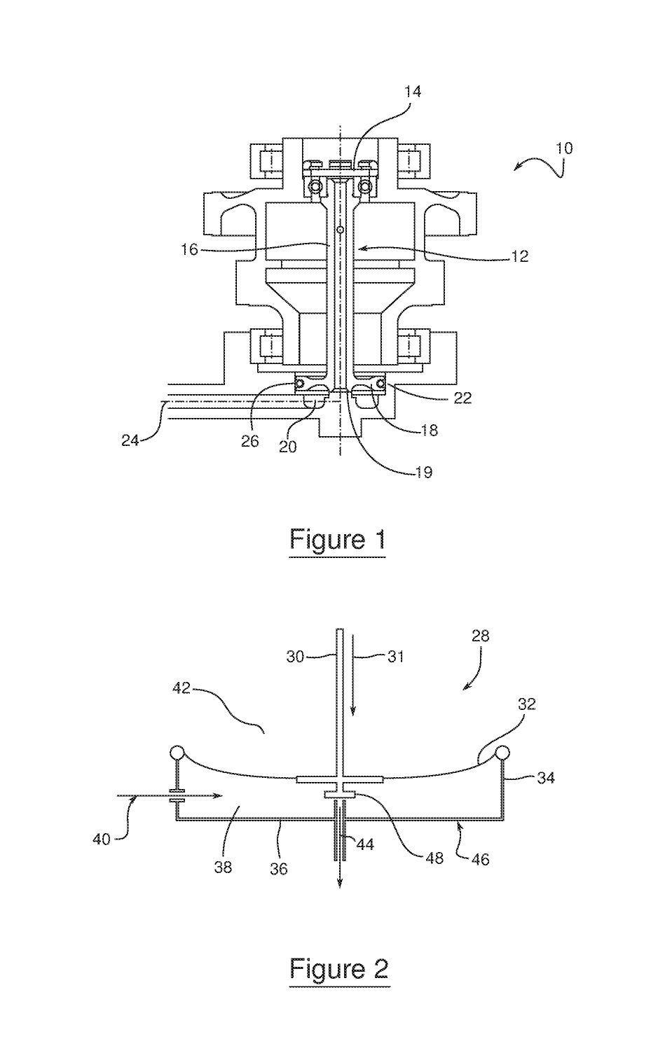

FIG. 1 shows a hydraulic torquemeter 10 according to the prior art. Said hydraulic torquemeter comprises in particular a piston 12 which is translatable in a longitudinal direction under the effect of axial thrust which is representative of the torque to be measured. The axial thrust is transmitted to the upper portion 14 of the piston and is transmitted by the pin 16 of the piston to the cylindrical piston head 18 which is in contact with a fluid 20 and moves within a hollow cylinder 22 which has a diameter that is slightly larger than that of the piston head 18 so as to enable said piston to move with a minimum amount of play. A supply hydraulic circuit 24 circulates the fluid 20. The closure of the drain segment in the region of a valve 19 supported on the end of the rod, under the effect of the axial thrust, increases the pressure of the fluid 20 in the cylinder 22 until the axial thrusts are balanced (when the thrust which is representative of the torque to be measured and the hydraulic thrust of the fluid 20 on the head of the piston 18 are exactly equal). The pressure of the fluid 20 when this balance is achieved is therefore highly proportional to the torque to be measured.

To prevent the fluid 20 from travelling outside the hydraulic circuit 24, in particular into the portion where the pin 16 of the piston moves, the head 18 of the piston is provided with an O-ring seal 26 which surrounds the head 18 of the piston and makes it possible to eliminate the play between the head 18 of the piston and the hollow cylinder 22 in order to prevent the fluid 20 from passing through by compressing the seal between the head 18 of the piston and the hollow cylinder 22. Furthermore, a collar made of PTFE is placed between the O-ring 26 and the cylinder 22. The seal 26 being compressed creates friction which is detrimental to the quality of the torque measurement and results in a hysteresis phenomenon.

The invention makes it possible to solve these problems.

Therefore, according to an embodiment of the invention as shown in FIG. 2, the torquemeter 28 comprises a rod 30 which is translatable in a longitudinal direction under the effect of axial thrust 31 which is representative of the torque to be measured. The movable rod 30 is rigidly connected to a flexible membrane 32. The flexible membrane 32 extends in a plane which is substantially perpendicular to the rod 30. Furthermore, said membrane is sealingly fixed to the lateral walls 34 of a pressure chamber 36. This pressure chamber 36 is supplied with a fluid 38 from a hydraulic circuit 40. The membrane 32 separates the pressure chamber 36 from a space 42 in which the movable rod 30 moves.

The axial thrust 31 is representative of the torque to be measured. To bring about this axial thrust 31, the torquemeter 28 comprises, for example, conversion means suitable for applying this axial thrust 31 in a manner dependent on the torque to be measured. For example, these conversion means may comprise an intermediate pinion which has helical toothing and is located on the line of the shaft of which the torque is to be measured. The torque transmitted by the intermediate pinion produces, by means of the helical toothing, thrust of which the component in the axis of rotation is proportional to this torque: this normal component is the axial thrust 31 transmitted to the movable rod 30.

The movement of the movable rod 30 caused by the axial thrust 31 deforms the membrane 32 which is rigidly connected to the rod. The closure of the drain segment in the region of a valve 48 supported on the end of the rod 30 increases the pressure of the fluid 38 in the chamber 36 until the axial thrusts are balanced. In other words, the pressure of the fluid 38 is adjusted in the pressure chamber 36 by means of a valve 48 which varies the segment for drainage through the port 44.

The pressure chamber 36, the membrane 32 and the drain port 44 form a manometric capsule 46.

The architecture of a torquemeter of this kind prevents the membrane 32 from being translatable. The membrane can only deform elastically. Consequently, the problems relating to friction and hysteresis in known hydraulic torquemeters are eliminated as a result of the membrane not being translatable.

The pressure of the fluid 38 is measured, for example by a pressure sensor. The information on the measured pressure can be transmitted to a user, for example by means of a display unit. In that case, the display unit can either directly display the pressure value measured by the sensor if the user knows or can easily deduce the torque value on the basis of the displayed pressure value, or display a torque value calculated by the means for determining the torque on the basis of the measured pressure, for example a computer or another conversion system.

Alternatively, the pressure value is not measured by a sensor, but rather the pressure itself causes the torque value to be displayed on the display unit, for example by a needle moving on a display unit by means of a suitable mechanism, without directly measuring the pressure value.

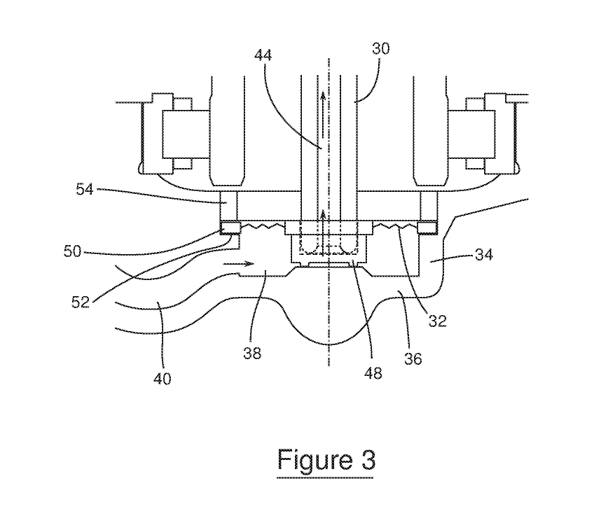

FIG. 3 is a schematic view of a hydraulic torquemeter 28 according to the embodiment of the invention and shows again and details the elements shown in FIG. 2. The movable rod 30 is connected to the membrane 32 by means of a socket in which one end of the movable rod 30 is pushed, The socket, which is pierced in the centre thereof, is sealingly attached to the membrane 32 over the entire periphery thereof and forms the valve 48 which regulates hydraulic drainage in such a way as to balance the pressure in the chamber 36, The membrane 32 extends as far as the lateral wall 34 of the pressure chamber 36. The membrane 32 is surrounded by a ring 50 which is in contact with a shoulder 52 of the lateral wall 34 of the pressure chamber 36. The ring 50 is held in contact with the shoulder 52 by means of a holding collar 54. The ring 50, the shoulder 52 and the collar 54 ensure that the system is sealed. Unlike the piston and the seal from the prior art, the ring 50, the shoulder 52 and the collar 54 ensure sealing whilst being static and not playing a role in adjusting the pressure of the fluid 38. Therefore, said elements do not have the same disadvantages as the piston-seal system from the prior art.

The invention is particularly suitable for being mounted in a turboshaft engine of an aircraft.

1. Hydraulic torquemeter comprising:
a rod translatable in a longitudinal direction under the effect of axial thrust which is representative of the torque to be measured;
a hydraulic circuit in which a fluid flows; and
a manometric capsule comprising:
a pressure chamber which is supplied with fluid by said hydraulic circuit,
a sealed flexible membrane in contact with the fluid in the pressure chamber, wherein the sealed flexible membrane extends in a plane which is substantially perpendicular to said rod, and is rigidly connected to the rod in such a way that a longitudinal movement of the rod deforms the membrane,
a drain port in said pressure chamber, which is joined to a valve supported on one end of said rod so as to adjust the pressure of the fluid in said pressure chamber according to the deformation of said membrane.

2. Torquemeter according to claim 1, wherein said rod is hollow and forms part of said hydraulic circuit.

3. Torquemeter according to claim 2, wherein said hollow rod passes through said flexible membrane, and wherein said drain port is provided on the end of said hollow rod.

4. Torquemeter according to claim 1, wherein said membrane is surrounded by a ring which is held in contact with a shoulder of the pressure chamber by a holding collar.

5. Torquemeter according to claim 1, further comprising a converter configured to apply axial thrust which is representative of the torque to be measured to the rod.

6. Torquemeter according to claim 1, further comprising means for determining the torque according to the pressure of said fluid.

7. Turboshaft engine comprising:
a rotating shaft, and
a hydraulic torquemeter of claim 1, which is configured to measure the torque of the shaft.
